(19) United States
(12) Patent Application Publication
(10) Pub. No.: US 2026/0017317 A1
(43) Pub. Date: Jan. 15, 2026

(54) ZERO-SHOT REASONING IN VISION-LANGUAGE MODELS

(71) Applicant: National University of Singapore, Singapore (SG)

(72) Inventors: Zhihe LU, Singapore (SG); Xinchao WANG, Singapore (SG); Min YUAN, Singapore (SG)

(21) Appl. No.: 19/264,116

(22) Filed: Jul. 9, 2025

(30) Foreign Application Priority Data
Jul. 10, 2024 (SG) 10202402035Y

(51) Int. Cl. G06F 16/583; G06F 16/532; G06F 16/55; G06V 10/74

(52) U.S. Cl. CPC G06F 16/5854; G06F 16/532; G06F 16/55; G06F 16/5838; G06V 10/761

(57) ABSTRACT

Disclosed are examples of training-free systems, methods and apparatuses, rooted in Chainof-Thought (CoT) reasoning, used to enhance the zero-shot performance of vision language models (VLMs) such as CLIP on a variety of downstream tasks. Hierarchical questions reflecting human visual cognition can be used with a pre-trained visual question answering model to extract the context of a query image from a global to local perspective through strategic questioning. Those CoT-based question-answer (QA) pairs, in conjunction with predefined class names, can serve as input to a language encoder, resulting in multi-level textual embeddings that emphasize various aspects of the image to improve existing VLM performance without additional training or labelled data.

### RELATED APPLICATIONS

The present application claims priority to Singapore Provisional Application No. 10/202,402035Y filed on Jul. 10, 2024, by the National University of Singapore the content of which is incorporated by reference herein.

### TECHNICAL FIELD

This application relates generally to systems, methods, and apparatuses, including computer program products, for improving the function of vision language models (VLMs) through the use of chain of thought (CoT) prompting.

### BACKGROUND

Vision-language models (VLMs), e.g., Contrastive Language-Image Pre-training (CLIP) and ALIGN (A Large-scale ImaGe and Noisy-text embedding), have demonstrated increasing potential in various computer vision (CV) tasks, including image classification, semantic segmentation, and object detection.

These models have revolutionized conventional CV models by endowing them with open-vocabulary capabilities, thereby overcoming the limitations that traditionally restricted pretrained models to closed-set functionalities. This advancement is often achieved through a language-based classifier that leverages class names to identify query images by calculating the similarity between visual features and textual embeddings, Pre-trained VLMs have exhibited remarkable zero-shot performance. Nevertheless, this performance is not uniformly satisfactory across various datasets. This variance in performance can be attributed to the distributional discrepancy between the models' training data and the target data. Accordingly, further adaptation of the VLMs is often needed for improved task-specific performance.

Prompt learning has emerged as a potent technique for enhanced performance of VLMs on downstream tasks. The concept of prompt learning was first proposed in natural language processing, which has been recently adapted for fine-tuning VLMs.

The essence of prompt learning in VLMs lies in the learning of a task-specific prompt template through optimization on targeted datasets. This strategy offers two advantages: (i) The tailored template is more effective for the task than generic templates like “a photo of {class}”, and (ii) it significantly reduces the burden of manual prompt engineering. However, the process of crafting these bespoke templates relies on the availability of labeled data, a requirement that may not always be met in real-world scenarios.

### SUMMARY

In various embodiments, systems, methods and apparatuses mimic human visual perception to enhance the zero-shot performance of VLMs, specifically through the design of chain-of-thought based question-answering pairs and prompt ensemble that leverages multiple pairs for a more comprehensive perception. By leveraging the way humans piece together information to form a coherent understanding of visual stimuli, the models herein demonstrate improved accuracy and efficiency in zero-shot learning tasks. This significantly improves the function of AI systems themselves without the need for additional training or data labelling, allowing for VLMs capable of understanding context and nuances in a manner previously unattainable.

The systems, methods and apparatuses herein address the shortcomings in existing VLM methods including that pre-trained VLMs can encounter performance degradation when applied to datasets that diverge from their training data, a phenomenon primarily attributed to two factors. A first factor is the distribution shift, where the discrepancy between the statistical properties of the training and test datasets leads to a mismatch in model expectations versus actual input. This shift can significantly hinder the model's ability to generalize its learned patterns to new, unseen data. A second factor is the utilization of overly generic prompt templates, which plays a role in the model's underperformance. These templates often fail to incorporate contextual nuances essential for making accurate predictions or generating relevant responses, thereby limiting the model's effectiveness in handling specific or complex queries.

A limitation of prompt-learning-based methods is that they necessitate additional labeled data for the optimization of learnable prompts. This requirement poses a significant challenge in real-world applications, where acquiring such labeled datasets may not be feasible or practical.

The systems, methods and apparatus disclosed herein address the existing limitations, providing a training-free and labeling-free technique, aimed at enhancing the zero-shot capabilities of vision-language models in downstream tasks. The systems, methods and apparatus disclosed herein incorporate chain of thought (CoT) to advance VLMs' zero-shot learning performance without the need for additional training or labeling, allowing for seamless incorporation into a frozen VLM and thereby improving the function of existing VLMs.

The systems, methods and apparatus disclosed herein incorporate chain of thought prompting to advance the zero-shot learning performance of pre-trained vision-language models. Incorporating chain-of-thought (CoT) into pre-trained vision-language models (VLMs) marks a pioneering advancement in zero-shot learning performance. This technique enhances VLMs by endowing them with advanced reasoning abilities, allowing for a layered understanding of visual contexts and augmenting textual descriptions. This refined textual insight facilitates the creation of more robust classifiers, improving the recognition of visual objects.

The Systems, methods and apparatuses herein can be implemented without additional training. An advantage of this is a significant reduction in the resources and time required for model preparation. Without the need for training, computational power, and time typically involved in training models, this approach allows for immediate deployment and application, making it highly efficient and cost-effective. By saving computational power and increasing efficiency, the function of the computer itself is improved while performing VLM functions using the disclosed methods.

Additionally, as discussed herein, systems, methods and apparatuses do not require additional labeled data. This feature reduces the need for time-consuming and costly data annotation, making the disclosed methods cost-effective and scalable across different domains without the limitation of sourcing domain-specific labeled datasets.

As noted, in part because no additional training or labeled data is needed, the disclosed systems and methods can be seamlessly integrated into existing VLMs. This facilitates quick enhancements to current systems without the need for significant modifications, thereby saving time and resources while leveraging existing architectures for improved performance.

As discussed in more detail below, the mechanism of chain of thought (CoT) can be used to augment the standard “a photo of” prompt template through hierarchical perceptions. These perceptions can be derived using a visual question answering (VQA) pipeline, where a pre-trained VQA model such as BLIP (Bootstrapped Language-Image Pretraining), is used to extract semantic information in response to specific questions. The systems, methods and apparatuses herein can use CoT-based questions, drawing inspiration from the natural process of human visual perception, which typically ranges from global to local understanding. For instance, humans might initially notice colors, then discern living beings, and eventually observe intricate details like patterns. Applying this analogy, a series of CoT-based questions can be formulated to capture multi-level information from a query image. This series might start with a question like “What colors are predominant in the image?” followed by “Are there any people or animals in the image? If yes, what are they doing?” and concluding with “Can you describe notable textures or patterns visible?”

Building upon a frozen VQA model's question-answer pairs, the systems, methods and apparatuses herein can further utilize this information to augment prompt templates. For example, each question-answer pair can be concatenated to a standard prompt, enriching the textual embeddings with both semantic information and contextual understanding at multiple levels. Similarity scores can then be calculated between these multi-level textual embeddings and the image features in a query image, integrating these scores in an ensemble manner for a more holistic perception of the query image.

In various embodiments, this can lead to more accurate and context-aware image recognition by effectively paralleling human cognitive processes through the adoption of a CoT-based mechanism. The systems, methods and apparatuses herein can thereby provide nuanced and layered understanding of visual content, demonstrating a simple yet robust strategy for advancing VLMs' zero-shot learning capabilities without additional training or labeling requirements.

In one embodiment, a computerized method is provided for improving prompting in a vision-language model (VLM), Methods can include the steps of providing a plurality of questions and a query image to a pre-trained visual question answering (VQA) model; receiving, from the VQA model, corresponding answers to each of the plurality of questions; pairing the corresponding answers with each of the plurality of questions to construct a plurality of question-answer (QA) pairs; generating a series of enhanced prompts, each enhanced prompt incorporating one of the plurality of QA pairs; processing each of the enhanced prompts using a language encoder to produce a set of textual embeddings; aggregating the set of textual embeddings to produce a fused textual embedding; and classifying the query image with the

VLM based on the fused textual embedding,

In various embodiments, aggregating can include averaging the set of textual embeddings. Classifying the query image can include computing feature-level similarity between the query image's visual features and the fused textual embedding. The plurality of questions can include at least 3 questions. In some embodiments, the plurality of questions can comprise at least 6 questions. The plurality of questions can include one or more first level questions, one or more second level questions, and one or more third level questions. In various embodiments, the plurality of questions can include one first level question, one second level question, and four third level questions. In some embodiments, the plurality of questions can include one or more questions selected from the group consisting of: “What colors are predominant in the image?”, “Are there any people or animals in the image and, if yes, what are they doing?”; “What is the emotional tone or mood of the image?”; “Are there any notable textures or patterns visible?”; “If there are people, what are their expressions and how do they interact with the environment of other subjects?”; and “How does the composition of the image (like the arrangement of subjects and objects) contribute to its overall impact?”

In certain embodiments, the VQA model and VLM can be different models. The VQA model and the VLM can include one or more of a contrastive language-image pre-training (CLIP) model and a bootstrapping language-image pre-training (BLIP) model. Methods of the invention can further comprise retrieving, from a database, text content related to the classified query image based on the fused textual embeddings.

In another embodiment, a non-transitory computer readable medium is provided having software encoded thereon. The software, when executed by one or more computing devices, may be operable to: provide a plurality of questions and a query image to a pre-trained visual question answering (VQA) model; receive, from the VQA model, corresponding answers to each of the plurality of questions; pair the corresponding answers with each of the plurality of questions to construct a plurality of question-answer (QA) pairs; generate a series of enhanced prompts, each enhanced prompt incorporating one of the plurality of QA pairs; process each of the enhanced prompts using a language encoder to produce a set of textual embeddings; aggregate the set of textual embeddings to produce a fused textual embedding; and classify the query image with the VLM by computing feature-level similarity between the query image's visual features and the fused textual embedding.

In still another embodiment computer systems are provided for improving prompting in a vision-language model (VLM). Systems can include a processor in communication with a non-transient memory and operable to perform the steps of providing a plurality of questions and a query image to a pre-trained visual question answering (VQA) model; receiving, from the VQA model, corresponding answers to each of the plurality of questions; pairing the corresponding answers with each of the plurality of questions to construct a plurality of question-answer (QA) pairs; generating a series of enhanced prompts, each enhanced prompt incorporating one of the plurality of QA pairs; processing each of the enhanced prompts using a language encoder to produce a set of textual embeddings; concatenating the set of textual embeddings to produce a fused textual embedding; and classifying the query image with the VLM based on the fused textual embedding.

In various embodiments encoded software and/or systems can be operable to perform any and all of the aforementioned techniques.

### BRIEF DESCRIPTION OF THE DRAWINGS

The advantages of the systems, methods and apparatuses described above, together with further advantages, may be better understood by referring to the following description taken in conjunction with the accompanying drawings. The drawings are not necessarily to scale, emphasis instead generally being placed upon illustrating the principles of operation.

FIG. 1 illustrates the use of thought chains in human visual perception.

FIG. 2 shows an example method for improving prompting in a vision-language model (VLM).

FIG. 3 illustrates an example embodiment of a method for enhancing VLM performance using QA pairs in a training-free manner.

FIG. 4 illustrates reasonable examples of visual question answering on different datasets.

FIG. 5 illustrates certain unreasonable examples of visual question answering on different datasets.

### DETAILED DESCRIPTION

Through pre-training on approximately 400 million image-text pairs, CLIP aims to align visual and textual modalities within a single embedding space, leveraging a contrastive learning loss for this purpose. Such pre-training confers upon CLIP the ability to discern extensive visual concepts and acquire adaptable visual representations. When classifying images, the model computes the cosine similarity between the vision encoder-derived feature vector f and textual embeddings {cᵢ|i ∈ 1, . . . ,K} from the language encoder, based on prompts tailored to K categories. The prompts often consist of “a photo of a {class}”, along with the names of the categories. This innovative classification mechanism empowers CLIP to adapt readily to new tasks, requiring only the introduction of relevant category names. The zero-shot inference can be formulated as follows, where cos (·,·) is the cosine similarity function and τ is the learned temperature parameter:

$$p ( y = i \vert x ) = \frac{exp ( \frac{cos ( f , {c}_{i} )}{τ} )}{{\sum }_{j = 1}^{K} exp ( \frac{cos ( f , {c}_{j} )}{τ} )}$$

The standard prompt template used in existing VLM models can be expressed as “a photo of a {class}”. This template, however, often lacks the contextual specificity required for targeted domain applications, leading to suboptimal performance. In response, research into prompt engineering has demonstrated the potential for customized prompts to enhance model performance significantly. For instance, CLIP illustrates that task-specific prompt modifications, such as “A photo of a {class}, a type of pet,” yield improved zero-shot performance on datasets like OxfordPets compared to the generic template. Nonetheless, this approach has three primary limitations:
(i) The development of effective prompts typically entails a labor-intensive and time-consuming process of trial and error.
(ii) Identifying the optimal prompt configuration for a specific task is challenging due to the sensitivity of model outputs to minor variations in prompt phrasing. and
(iii) Prompts tailored for one domain may not translate well to new or different domains.

These limitations significantly impede the advancement and practical applicability of prompt engineering.

Prompt learning represents an evolution in prompt engineering, introducing the concept of task-specific template learning. This approach employs M learnable vectors to substitute the conventional prompt template, exemplified by “[V]₁[V]₂ . . . [V]_{M}{class}”. While this method has demonstrated enhanced performance through its adaptive learning capability, its dependence on labeled data for fine-tuning poses a challenge for deployment in real-world scenarios, where such data might be scarce or unavailable.

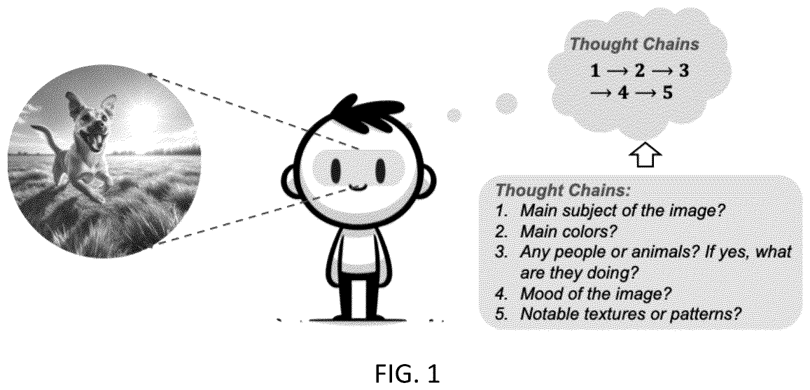

To address the pitfalls of prompt engineering and prompt learning in VLMs, systems, methods and apparatuses herein provide a new prompt generation technique, which requires neither training nor labeling. Specifically, CoT-based question-answer (QA) pairs are constructed to capture the context of the query image from diverse levels, and those QA pairs can then be incorporated into the standard prompt to enhance VLMs through an ensemble strategy. FIG. 1 illustrates the use of CoT in human visual perception.

Table 1 below provides examples of CoT-based questions that might be used with the systems, methods and apparatuses herein to improve the accuracy and function of VLM models. Question 1 is an example of the first level, designed to establish foundational context. Question 2 represents the second level, introducing a higher degree of complexity and detail. Questions 3 through 6 are classified as third level questions, each probing deeper into intricate aspects of the image, demanding a more nuanced understanding and interpretation.

TABLE 1

| Num | Question |
|---|---|
| 1 | What colors are predominant in the image? |
| 2 | Are there any people or animals in the image? If yes, what are they doing? |
| 3 | What is the emotional tone or mood of the image? |
| 4 | Are there any notable textures or patterns visible? |
| 5 | If there are people, what are their expressions and how do |
| | they interact with the environment or other subjects? |
| 6 | How does the composition of the image (like the arrangement |
| | of subjects and objects) contribute to its overall impact? |

Drawing inspiration from the intricacies of the human visual perception process, as illustrated in FIG. 1, the CoT methods herein are able to deepen the understanding of image contexts. A series of questions can be formulated to decode the visual narrative of an image, spanning from identifying the main subject and discerning colors to interpreting activities, gauging mood, and noticing detailed patterns, as shown in Table 1. Using those questions, visual question answering (VQA) models can be employed to automatically provide answers based on the target or query image. Specifically, for each formulated question q, it can be input alongside the query image x into a pre-trained VQA model Θ_{vqa}. This model can be designed to process the image and the question, generating an answer yₐ that reflects a segment of the image's context, which can be defined as

$${y}_{a} = {Θ}_{vqa} ( q , x ) .$$

The above procedure can be iteratively applied to a set of questions tailored to explore various aspects of the image. Through this iterative questioning and answering cycle, a rich set of QA pairs can be generated. These pairs collectively furnish a holistic and multi-dimensional understanding of the image, mirroring the depth and width of human visual perception. This approach not only automates the extraction of nuanced image contexts without direct human intervention but also leverages the capabilities of existing VQA models.

The integration of question-answer (QA) pairs into the standard prompt, ‘a photo of a {class}’, represents a new strategy to enrich image understanding through textual augmentation. Specifically, assuming a collection of N QA pairs, a series of enhanced prompts can be generated. Each prompt can incorporate a unique QA pair as prepared above, resulting in a format such as ‘a photo of a {class}, question: Qⱼ, answer: Aⱼ.’ for j=1, . . . , N. This methodological innovation allows for a multifaceted exploration of the image. Upon generating these enhanced prompts, each can then be processed by a language encoder to produce a corresponding set of textual embeddings. These embeddings can thereby encapsulate both the categorical and contextual information derived from the QA pairs.

To leverage the diversity and depth of information contained within these embeddings, an ensemble fusion strategy can be used which aggregates the embeddings by averaging to synthesize a unified representation that is robust and informative. Subsequently, the fused embeddings can be used to classify the image. This can be achieved by computing the feature-level similarity between the image's visual feature and the fused textual embeddings, facilitating a more context-aware classification process. That process can be formulated as follows, where Eᵥ(·)/Eᵣ(·) is the vision/language encoder, f=Eᵥ(x), K is the number of categories, cos (·,·) is the cosine similarity function and t is the learned temperature parameter:

$${P}_{j} = ‘ a photo of a \{ class \} , question : {Q}_{j} , answer : {A}_{j} . ’ , j = 1 , … , N . \\ {C}_{fused , i} = \frac{1}{N} {\sum }_{j = 1}^{N} {E}_{t} ( {P}_{j} \vert y = i ) , \\ p ( y = i \vert x ) = \frac{exp ( \frac{cos ( f , {c}_{fused , i} )}{τ} )}{{\sum }_{m = 1}^{K} {exp ( \frac{cos ( f , {c}_{fused , m} )}{τ} )}^{′}}$$

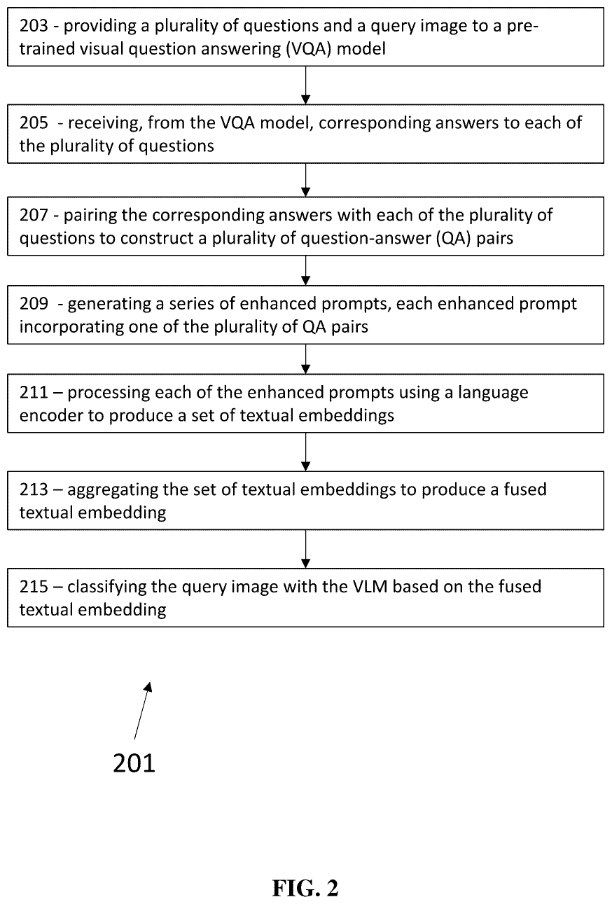

FIG. 2 shows an example method 201 for improving prompting in a vision-language model (VLM). The method includes providing 203 a plurality of questions and a query image to a pre-trained visual question answering (VQA) model, receiving 205, from the VQA model, corresponding answers to each of the plurality of questions, and pairing 207 the corresponding answers with each of the plurality of questions to construct a plurality of question-answer (QA) pairs. A series of enhanced prompts can then be generated 209, each enhanced prompt incorporating one of the plurality of QA pairs before processing 211 each of the enhanced prompts using a language encoder to produce a set of textual embeddings. The set of textual embeddings can then be aggregated 213 to produce a fused textual embedding before classifying 215 the query image with the VLM based on the fused textual embedding.

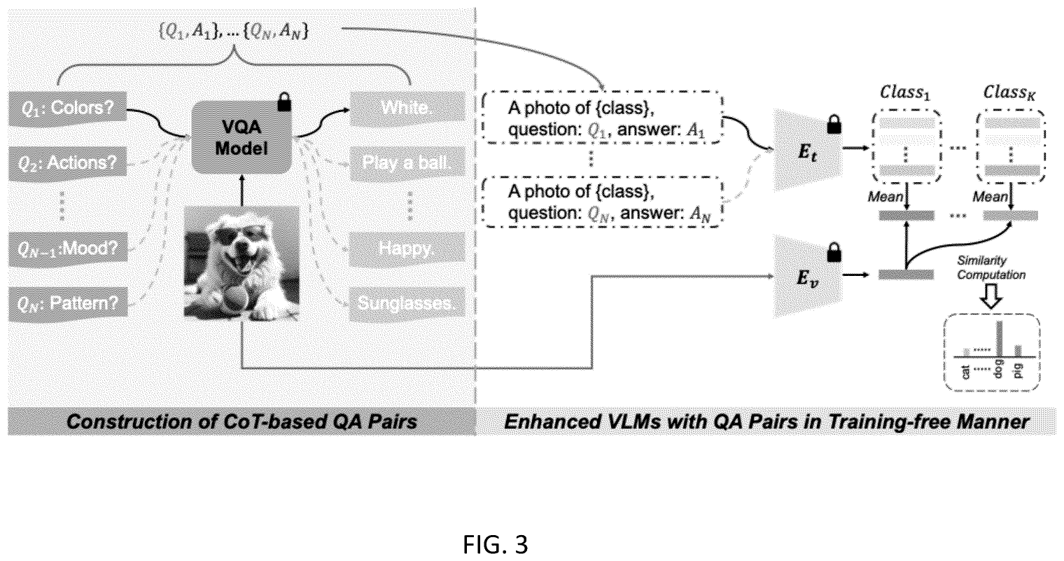

FIG. 3 illustrates an example embodiment of a method for enhancing VLM performance using QA pairs in a training-free manner. As shown, the method includes two stages: (i) construction of chain of thought (CoT) based question-answer (QA) pairs, and (ii) integration of the QA pairs into a vision-language model (VLM), e.g., CLIP, for zero-shot inference, Class; denotes the embeddings extracted for the i-th class,

The vision-language models (VLMs) discussed herein mainly refer to the methods belonging to language driven visual representation learning (LDVRL),

The purpose of LDVRL is to learn a common latent space, where textural embeddings and visual embeddings are well-aligned. Early studies in the intersection of language and vision modeling have adopted diverse methodologies. For textual data, studies have leveraged unsupervised pre-trained models and skip-gram text modeling techniques. Conversely, in the visual domain, approaches such as sparse coding and vector quantization along with the exploitation of Classeme features have been explored. Recent works often employ dual deep neural networks, specifically Transformers, to independently process language and vision inputs.

These studies predominantly engage in pre-training on extensive datasets comprising millions or billions of image-text pairs sourced from the internet, e.g., ˜400 million for CLIP and ˜1 billion for ALIGN, utilizing a contrastive learning mechanism. This approach has enabled the development of pre-trained VLMs that demonstrate remarkable zeroshot generalization capabilities across a diverse array of downstream tasks. However, the presently disclosed systems, methods and apparatuses offer further advances in the zero-shot generalization of VLMs by leveraging reasoning capability.

Prompt learning, initially conceptualized within the domain of natural language processing, facilitates the automatic generation of prompts through optimization for specific downstream tasks,

This paradigm has been recently extended to VLMs to streamline efficient fine-tuning processes. Notable innovations inclue CoOp, which finetunes CLIP through the optimization of a continuous prompt vector array within its language component for few-shot image recognition. Meanwhile, CoCoOp addresses the tendency of CoOp towards overfitting by introducing conditional prompts that leverage visual features, thereby enhancing generalization capabilities across tasks. Recently, this exploration has expanded beyond the confines of language-based prompt learning to embrace multi-modal prompt learning strategies. For instance, MaPLe pioneers an approach involving simultaneously learning hierarchical prompts across both vision and language branches of CLIP. Further advancing this domain, PromptSRC introduces self-regulating prompts that enhance transferability through the incorporation of three regularization terms, ensuring that the optimized space closely aligns with the original pre-trained model space. However, in contrast to the presently disclosed systems, methods and apparatus, all above techniques need additional labeled data for prompt learning, limiting their applicability to real-world scenarios where such labels do not always exist.

As described herein, the function and results of the VLMs themselves can be further enhanced by focusing on generating effective prompts without the need for extra training, labeled data, or extensive prompt engineering.

The concept of chain of thought (CoT) prompting was first applied to natural language processing (NLP), which demonstrates that the incorporation of intermediate reasoning steps can remarkably enhance the reasoning capabilities of large language models. This laid the foundation for numerous NLP studies that build upon the chain-of-thought framework. Subsequently, zero-shot CoT proposed a simple method by solely adding “Let's think step by step” to the original prompt. Based on that, Auto-CoT proposed an approach to eliminate manual efforts by question clustering and demonstration sampling.

Recently, some works have introduced CoT to multimodel learning, e.g., visual question answering and language-driven visual classification. Specifically, a series of chained prompts was used within the framework of CoCoOp. However, that technique still required labeled data for fine-tuning as opposed to the currently described systems and methods that leverage CoT for enhancing the zero-shot performance of VLMs without relying on labeled data or additional training.

In various embodiments, the proposed training-free and labeling-free systems, methods and apparatuses herein for enhancing vision-language models can address several issues with current models including:

1. Reducing Deployment Costs: By eliminating the need for extensive data collection and manual labeling, users can significantly cut costs associated with preparing models for deployment. This reduction in cost makes the technology more accessible to smaller enterprises and startups.

2. Faster Time-to-Market: Without the requirement for extensive training phases, models can be deployed much quicker. This accelerates the product development cycle, enabling users to bring their AIdriven solutions to market faster.

3. Scalability Across Domains: The method's ability to enhance zero-shot capabilities means that the same model can be adapted to multiple domains or tasks without retraining. This scalability is particularly beneficial for users operating in multiple sectors or with varied product lines.

4. Increased Model Versatility: Users can use a single model for a variety of applications, reducing the need for specialized models for each task. This versatility can lead to a more streamlined operation and reduced overhead in managing multiple AI systems.

5. Enhanced Performance in Low-Resource Settings: In applications where data privacy concerns or the unavailability of large, labeled datasets are prevalent, this method can still deliver high-performance AI solutions. This is especially crucial in sectors like healthcare and finance, where data sensitivity is a primary concern.

6. Support for Emerging Markets: The approach can democratize access to advanced AI technologies in regions that may not have the resources for extensive data collection and labeling. This can drive innovation and growth in emerging markets by providing state-of-the-art technology solutions that are both affordable and effective.

7. Risk Mitigation: Reducing reliance on large, labeled datasets minimizes the risk of models developing biases based on the data they are trained on. This can lead to more fair and equitable AI solutions, which is increasingly important as these technologies become more pervasive in critical decision-making processes.

### EXAMPLES

Example 1:11 diverse datasets were used for experimentation using zero-shot evaluation of various example methods described above. Experiments were conducted on datasets, encompassing a broad spectrum of visual domains. For quantitative assessment, classification accuracy served as the primary metric.

Datasets: Following previous methods, the testing incorporated 11 diverse datasets, selected to span a comprehensive array of recognition tasks. This selection strategy enables an exhaustive evaluation of the proposed model across various domains. Specifically, the benchmark suite includes:
Generic Object Classification: ImageNet and Caltech 101;
Fine-Grained Classification: Oxford Pets, Stanford Cars, Flowers102, Food101, and FGVCAircraft;
Scene Recognition: SUN397;
Action Recognition: UCF101;
Texture Classification: DTD; and
Satellite Imagery Recognition: EuroSAT.

Implementation Details: The BLIP model was leveraged for the generation of CoT-based QA pairs due to its popularity and impressive capability. The CoT-based questions are listed in Table 1, providing a structured overview of the question paradigms employed. For the vision-language integration, the CLIP architecture was used, specifically utilizing its VIT-B/16 image encoder variant. The prompt templates used for each dataset are in line with prior works and detailed below.

Methods were implemented with PyTorch. All the experiments were conducted on a single NVIDIA Geforce RTX 3090 GPU.

TABLE 2
Zero-shot evaluation.

| | | | | | Stanford | |
|---|---|---|---|---|---|---|
| Method | Average | ImageNet | Caltech101 | OxfordPets | Cars | Flowers102 |
| BLIP | 53.76 | 49.14 | 92.17 | 69.75 | 65.24 | 50.83 |
| CLIP | 65.27 | 66.72 | 82.94 | 89.07 | 65.29 | 71.30 |
| CLIP-EN | 65.70 | 68.73 | 94.12 | 88.42 | 65.79 | 67.52 |
| TOM | 66.16 | 68.53 | 94.60 | 88.36 | 64.72 | 72.47 |

| | | FGVC | | | | |
|---|---|---|---|---|---|---|
| Method | Food101 | Aircraft | SUN397 | DTD | EuroSAT | UCF101 |
| BLIP | 69.82 | 4.92 | 56.92 | 52.13 | 23.64 | 56.81 |
| CLIP | 86.11 | 24.87 | 62.62 | 44.56 | 47.69 | 66.77 |
| CLIP-EN | 85.64 | 23.16 | 66.30 | 45.15 | 50.43 | 67.43 |
| TOM | 85.71 | 25.56 | 66.26 | 42.20 | 51.67 | 67.72 |

All compared methods used no extra training or labeled data. CLIP-EN denotes the CLIP with prompt ensemble, where the ensemble templates are the 7 templates designed for ImageNet by prompt engineering (detailed below).

Zero-shot Evaluation: Table 2 shows the zero-shot evaluation for various methods.

Overall, an example method achieved new state-of-the-art performance in terms of the average accuracy across all 11 datasets.

Of note, CLIP was found to perform better than BLIP on Classification while BLIP offered a unified framework for vision language understanding and generation, setting new benchmarks across image-text retrieval, image captioning, and VQA tasks. Within the instituted pipeline, BLIP was leveraged for generating QA pairs. An intriguing aspect of our investigation centers on BLIP's capability in zero-shot classification. Mirroring the approach of CLIP, features were initially extracted from both visual and textual modalities, subsequently employing cosine similarity to acquire prediction scores. The evaluation, encompassing 11 varied datasets, is detailed in Table 2 above. Contrary to its impressive performance in other domains, BLIP exhibited significantly inferior results in classification tasks when compared to CLIP. This discrepancy highlights the importance of model selection based on task-specific requirements and further emphasizes the benefits of a universally adaptable model such as that described herein.

Recent work has expanded CLIP's utility beyond the standard prompt “a photo of {class}”, introducing seven specialized templates for ImageNet through extensive prompt engineering. This diversified prompt ensemble has been shown to enhance CLIP's accuracy on ImageNet by 2.01%. However, analysis reveals two limitations of this strategy. First, the effectiveness of the templates selected for one dataset is not uniform across different datasets. Specifically, the application of these ImageNet-optimized templates results in diminished performance on datasets such as OxfordPets, Flowers 102, Food101, and FGVC Aircraft. Second, identifying the optimal templates often necessitates a considerable amount of trial-and-error experimentation, limiting its practical applicability.

Contrary to previous methods of extensive prompt engineering, the systems, methods and apparatuses described herein involve the creation of templates through the formulation of QA pairs grounded in common sense reasoning. The experimental results show that this method outperforms alternative methods in terms of average accuracy, achieving the highest performance across five distinct datasets and comparable results on the remainder. These findings underscore the efficacy of TOM (an example embodiment of the presently described systems and methods), presenting an innovative avenue for prompt development.

TABLE 3
The effect of using different QA pairs.

| | | | | | Stanford | |
|---|---|---|---|---|---|---|
| #QA Pair | Average | ImageNet | Caltech101 | OxfordPets | Cars | Flowers102 |
| 1 | 64.25 | 67.02 | 94.08 | 87.00 | 64.87 | 69.14 |
| 2 | 63.14 | 64.83 | 92.62 | 84.41 | 63.18 | 67.28 |
| 3 | 65.42 | 68.45 | 94.08 | 88.47 | 63.41 | 70.32 |
| 4 | 63.15 | 66.32 | 93.43 | 86.37 | 60.18 | 67.76 |
| 5 | 65.68 | 68.05 | 94.16 | 89.42 | 65.45 | 70.60 |
| 6 | 65.20 | 66.85 | 94.00 | 89.18 | 64.57 | 73.12 |
| TOM | 66.16 | 68.53 | 94.60 | 88.36 | 64.72 | 72.47 |

| | | FGVC | | | | |
|---|---|---|---|---|---|---|
| #QA Pair | Food101 | Aircraft | SUN397 | DTD | EuroSAT | UCF101 |
| 1 | 85.06 | 24.57 | 65.72 | 41.78 | 41.41 | 66.09 |
| 2 | 84.17 | 22.92 | 62.55 | 41.90 | 42.59 | 68.04 |
| 3 | 85.60 | 23.97 | 65.53 | 41.25 | 50.88 | 67.64 |
| 4 | 84.52 | 23.28 | 63.97 | 31.26 | 53.77 | 63.76 |
| 5 | 85.11 | 24.27 | 63.78 | 39.54 | 54.22 | 67.86 |
| 6 | 85.58 | 24.30 | 63.78 | 37.17 | 51.84 | 66.77 |
| TOM | 85.71 | 25.56 | 66.26 | 42.20 | 51.67 | 67.72 |

The overall highest accuracy is denoted in bold, while the highest accuracy achieved using a single QA pair is underlined. Again, the QA pair numbering corresponds to the numbers in Table 1.

The Effect of Different QA pairs: The effect of using each QA pair for the prompt augmentation was further analyzed as shown in Table 3. From the results, two interesting observations can be made.

First, certain QA pairs demonstrated superior efficacy on specific datasets. For example, the question “What is the emotional tone or mood of the image?” (#QA Pair 3) paired with its corresponding answer significantly outperformed others on ImageNet and Food101 datasets. Conversely, queries focusing on human expressions and interactions, such as “If there are people, what are their expressions and how do they interact with the environment or other subjects?” (#QA Pair 5) yielded optimal results on Caltech101, OxfordPets, Stanford Cars, and EuroSAT. This variation underscores the importance of contextually relevant questions in enhancing the model's domain-specific image understanding.

Second, the utilization of a prompt ensemble generally leads to superior performance compared to employing a single prompt across the majority of test cases. Specifically, the average accuracy achieved by the prompt ensemble exceeds that of the optimal single prompt by 0.48%, with the ensemble method attaining the highest accuracy in 7 out of 11 datasets.

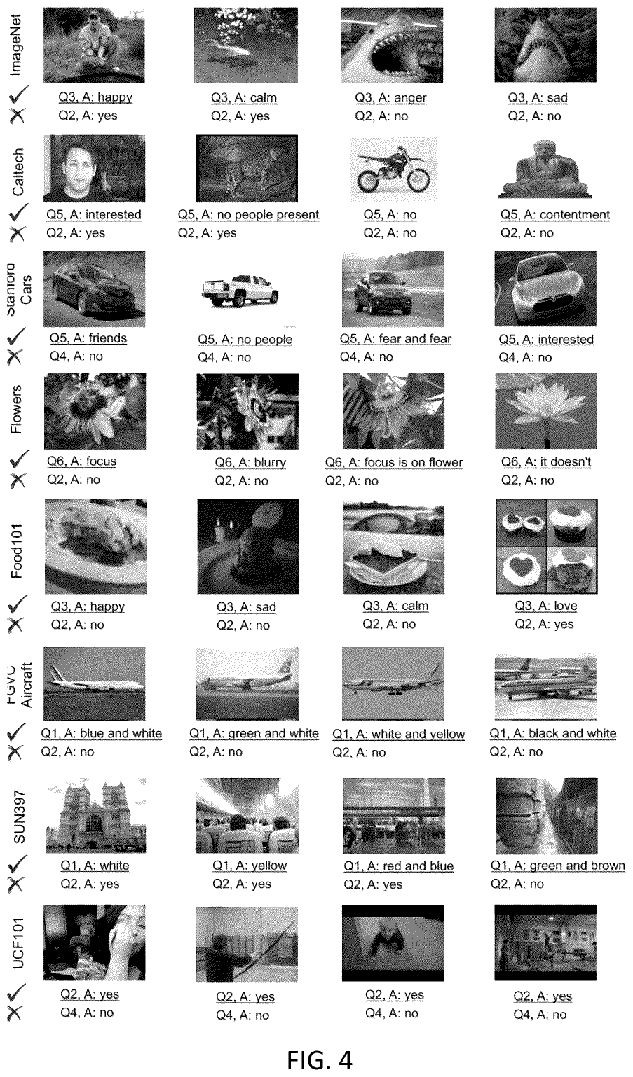

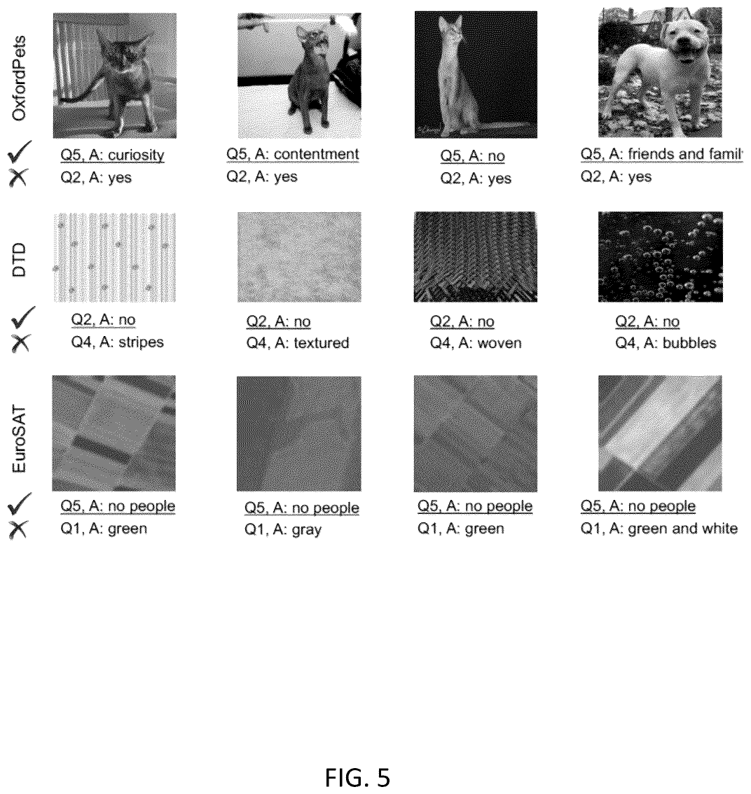

Further Analysis by VQA Visualization: To better understand how QA pairs work on diverse datasets, one can examine some VQA examples from each evaluated dataset as shown in FIGS. 4 and 5. Recognizing the distinct characteristics inherent to each dataset, the analysis adopts a dataset-specific perspective. FIG. 4 illustrates reasonable examples of visual question answering on different datasets. FIG. 5 illustrates certain unreasonable examples of visual question answering on different datasets. The check marks denote the best QA pair in the dataset while an X indicates the worst performing QA pair for that image.

ImageNet: In the evaluation of questions applied to the ImageNet dataset, Q3, which probes the ‘emotional tone or mood of the image,’ consistently yields accurate responses, irrespective of whether the depicted object is partially or fully visible. This contrasts remarkably with Q2, ‘Are there any people or animals in the image? If yes, what are their actions?,’ which emerges as the least effective.

Particularly, when the model is presented with partial views of objects, e.g., a shark, errors in the VQA model's responses become evident, as illustrated in the third and fourth columns of FIGS. 4 and 5. These inaccuracies suggest a deficiency in the model's ability to grasp contextual nuances, leading to suboptimal recognition performance.

Caltech101: On Caltech101, the most effective question is Q5—“If there are people, what are their expressions and how do they interact with the environment or other subjects?”. In contrast, asking Q2 leads to the worst performance though the answers are correct in most cases. This discrepancy suggests that the ability to interpret interactions between living entities and their surroundings plays a significant role in enhancing the model's overall performance for Caltech101.

Standford Cars: Similarly to the findings from the Caltech101 dataset, Q5 emerges as the most potent on the Stanford Cars dataset. This efficacy may be attributed to the frequent presence and interaction of people with cars, where querying these interactions facilitates the extraction of valuable insights, thereby enhancing recognition capabilities. Conversely, the given VQA model cannot find notable textures or patterns by asking Q4, naturally producing inferior performance.

Flowers102: On this dataset, Q6—‘How does the composition of the image, such as the arrangement of subjects and objects, contribute to its overall impact?’ is identified as the most effective. This effectiveness may be due to the fact that capturing aesthetically pleasing photographs of flowers typically requires a keen sense of beauty and an understanding of photographic principles, emphasizing the critical role of image composition. Given that the dataset exclusively comprises images without living creatures, it follows logically that Q2 is deemed the least relevant and, consequently, the least effective.

Food101: The performance trends of QA pairs on this dataset mirror those observed in the ImageNet dataset, with the most and least effective pairs being identical. Remarkably, the utility of ‘emotional tone’ questions in enhancing recognition capabilities extends even to a food dataset. This observation underscores the intriguing potential of leveraging emotional context as a means to improve model performance across diverse visual domains.

FGVC Aircraft: In the analysis of this dataset, Q1—‘What colors are predominant in the image?’ emerges as the most effective query. This is primarily because color serves as a principal feature when the subject matter is an entire airplane within the image. The absence of living entities within these images naturally renders Q2 the least effective.

SUN397: The efficacy of QA pairs on this dataset aligns with the findings from the FGVC Aircraft dataset. A notable distinction, however, is the presence of people in the images of this dataset. Despite their presence, these individuals are often considered part of the background, thereby being less effective.

UCF101: Contrary to the trend observed in other datasets where Q2 is deemed the least effective, in this dataset, it emerged as the most effective query. This deviation may be attributed to the prominence of human activities within the images. One surprising finding is that a simple affirmative response, ‘yes’, can enhance performance by 1.27%, underscoring the impact of contextual information on the overall accuracy of the model.

OxfordPets: On this dataset, although a marginal improvement is observed when Q5 is asked, the majority of the answers are incorrect. The primary issue appeared to be the VQA model's misclassification of animals as humans, leading to inaccurate responses. The observed improvement may be attributed to the CLIP model's inclination to concentrate on critical features, like the expressions on animal faces, and to leverage this information for improved recognition.

DTD: The performance of QA pairs on this dataset presents a paradox when compared to human cognitive processes. Conventionally, texture information, acquired through Q4, is considered vital for understanding this dataset, yet with this dataset, it results in the poorest performance. In contrast, Q2, which intuitively seems less relevant, emerges as the most effective. This discrepancy underscores the divergence between model processing and human reasoning, highlighting that the model's way of ‘thinking’ does not always align with human expectations.

EuroSAT: The results on this dataset exhibited a phenomenon akin to that observed in the DTD, reinforcing the observed disparity between model processing and human cognitive patterns Prompt Templates for Diverse Datasets:

TABLE 4
Specific prompt templates of 15 datasets

| Name | #Classes | #Train/Val/Test | Template |
|---|---|---|---|
| ImageNet | 1000 | 1.28M / — /50000 | “a photo of a {class}.” |
| Caltech101 | 100 | 4128 / 1649 / 2465 | “a photo of a {class}.” |
| OxfordPets | 37 | 2944 / 736 / 3669 | “a photo of a {class}, a type of pet.” |
| StanfordCars | 196 | 6509 / 1635 / 8041 | “a photo of a {class}.” |
| Flowers102 | 102 | 4093 / 1633 / 2463 | “a photo of a {class}, a type of |
| | | | flower.” |
| Food101 | 101 | 50500 / 20200 / 30300 | “a photo of a {class}, a type of |
| | | | food.” |
| FGVCAircraft | 100 | 3334 / 3333 / 3333 | “a photo of a {class}, a type of |
| | | | aircraft.” |
| SUN397 | 397 | 15880 / 3970 / 19850 | “a photo of a {class}.” |
| DTD | 47 | 2820 / 1128 / 1692 | “{class} texture.” |
| EuroSAT | 10 | 13500 / 5400 / 8100 | “a centered satellite photo of |
| | | | {class}.” |
| UCF101 | 101 | 7639 / 1898 / 3783 | “a photo of a person doing {class}.” |
| ImageNet-V2 | 1000 | — /— / 10000 | “a photo of a {class}.” |
| ImageNet-Sketch | 1000 | — / — / 50889 | “a photo of a {class}.” |
| ImageNet-A | 200 | — / — / 7500 | “a photo of a {class}.” |
| ImageNet-R | 200 | — / — / 30000 | “a photo of a {class}.” |

Table 4 details the specific prompt templates, along with the number of classes and dataset splits, across 15 diverse datasets. Each template was crafted to be context-sensitive, as commonly used in CLIP. The 7 selected prompt templates for ImageNet are listed in Table 5, as derived through extensive prompt engineering processes.

TABLE 5
The 7 selected templates for ImageNet

| # Num | Template |
|---|---|
| 1 | “itap of a {class}.” |
| 2 | “a bad photo of the {class}.” |
| 3 | “a origami {class}.” |
| 4 | “a photo of the large {class}.” |
| 5 | “a {class} in a video game.” |
| 6 | “art of the {class}.” |
| 7 | “a photo of the small {class}.” |

### EXAMPLE 2

### Experiments on ImageNet Variants

Evaluations were also conducted across several ImageNet variants: ImageNet-V2 , ImageNet-S, ImageNet-A, and ImageNet-R, with results detailed in Table 6. The results demonstrate that the systems, methods and apparatuses herein (TOM being an example embodiment) not only achieve a notable improvement over the zero-shot CLIP model, with an average accuracy improvement of 2.20%, but also exhibit superior performance compared to CoOp, even when CoOp is pretrained on ImageNet. The advancement presented by TOM further underscores the effectiveness of the disclosed approach, which explores multi-level perceptions of contextual information from query images.

TABLE 6
Experiments on ImageNet variants

| | Train on ImageNet | -V2 | -S | -A | -R | Avg. |
|---|---|---|---|---|---|---|
| CoOp | 64.20 | 47.99 | 49.71 | 75.21 | 75.21 | 59.28 |
| ClIP | 60.83 | 46.15 | 47.77 | 73.96 | 73.96 | 57.18 |
| TOM | 62.27 | 47.92 | 51.01 | 76.31 | 76.31 | 59.38 |

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing devices include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for improving prompting in a vision-language model (VLM), the method comprising:
providing a plurality of questions and a query image to a pre-trained visual question answering (VQA) model;
receiving, from the VQA model, corresponding answers to each of the plurality of questions;
pairing the corresponding answers with each of the plurality of questions to construct a plurality of question-answer (QA) pairs;
generating a series of enhanced prompts, each enhanced prompt incorporating one of the plurality of QA pairs;
processing each of the enhanced prompts using a language encoder to produce a set of textual embeddings;
aggregating the set of textual embeddings to produce a fused textual embedding; and
classifying the query image with the VLM based on the fused textual embedding.

2. The computerized method of claim 1, wherein aggregating comprises averaging the set of textual embeddings.

3. The computerized method of claim 1, wherein classifying the query image comprises computing feature-level similarity between the query image's visual features and the fused textual embedding.

4. The computerized method of claim 1, wherein the plurality of questions comprises at least 3 questions.

5. The computerized method of claim 4, wherein the plurality of questions comprises at least 6 questions.

6. The computerized method of claim 1, wherein the plurality of questions comprises one or more first level questions, one or more second level questions, and one or more third level questions.

7. The computerized method of claim 6, wherein the plurality of questions comprises one first level question, one second level question, and four third level questions.

8. The computerized method of claim 1, wherein the plurality of questions comprise one or more questions selected from the group consisting of:
what colors are predominant in the image;
are there any people or animals in the image and, if yes, what are they doing;
what is the emotional tone or mood of the image;
are there any notable textures or patterns visible;
if there are people, what are their expressions and how do they interact with the environment or other subjects; and
how does the composition of the image (like the arrangement of subjects and objects) contribute to its overall impact.

9. The computerized method of claim 1, wherein the VQA model and VLM are different models.

10. The computerized method of claim 1, wherein the VQA model and the VLM comprise one or more of a contrastive language-image pre-training (CLIP) model and a bootstrapping language-image pre-training (BLIP) model.

11. The computerized method of claim 1, further comprising retrieving, from a database, text content related to the classified query image based on the fused textual embedding.

12. A non-transitory computer readable medium having software encoded thereon, the software when executed by one or more computing devices operable to:
provide a plurality of questions and a query image to a pre-trained visual question answering (VQA) model;
receive, from the VQA model, corresponding answers to each of the plurality of questions;
pair the corresponding answers with each of the plurality of questions to construct a plurality of question-answer (QA) pairs;
generate a series of enhanced prompts, each enhanced prompt incorporating one of the plurality of QA pairs;
process each of the enhanced prompts using a language encoder to produce a set of textual embeddings;
aggregate the set of textual embeddings to produce a fused textual embedding; and
classify the query image with the VLM by computing feature-level similarity between the query image's visual features and the fused textual embedding.

13. The non-transitory computer readable medium of claim 12, wherein aggregating comprises averaging the set of textual embeddings.

14. The non-transitory computer readable medium of claim 12, wherein the plurality of questions comprises at least 3 questions.

15. The non-transitory computer readable medium of claim 14, wherein the plurality of questions comprises at least 6 questions.

16. The non-transitory computer readable medium of claim 12, wherein the plurality of questions comprises one or more first level questions, one or more second level questions, and one or more third level questions.

17. The non-transitory computer readable medium of claim 16, wherein the plurality of questions comprises one first level question, one second level question, and four third level questions.

18. The non-transitory computer readable medium of claim 12, wherein the plurality of questions comprise one or more questions selected from the group consisting of:
what colors are predominant in the image;
are there any people or animals in the image and, if yes, what are they doing;
what is the emotional tone or mood of the image;
are there any notable textures or patterns visible;
if there are people, what are their expressions and how do they interact with the environment or other subjects; and
how does the composition of the image (like the arrangement of subjects and objects) contribute to its overall impact.

19. The non-transitory computer readable medium of claim 12, wherein the VQA model and the VLM comprise one or more of a contrastive language-image pre-training (CLIP) model and a bootstrapping language-image pre-training (BLIP) model.

20. A computer system for improving prompting in a vision-language model (VLM), the system comprising a computing device comprising a processor and a memory storing instructions that, when executed by the processor, cause the processor to perform the steps of:
providing a plurality of questions and a query image to a pre-trained visual question answering (VQA) model;
receiving, from the VQA model, corresponding answers to each of the plurality of questions;
pairing the corresponding answers with each of the plurality of questions to construct a plurality of question-answer (QA) pairs;
generating a series of enhanced prompts, each enhanced prompt incorporating one of the plurality of QA pairs;
processing each of the enhanced prompts using a language encoder to produce a set of textual embeddings;
concatenating the set of textual embeddings to produce a fused textual embedding; and
classifying the query image with the VLM based on the fused textual embedding.
